(19) United States
(12) Patent Application Publication
(10) Pub. No.: US 2005/0171636 A1
(43) Pub. Date: Aug. 4, 2005

(54) Autonomous mobile robot cleaner system

(75) Inventor: Takao Tani, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/044,262

(22) Filed: Jan. 28, 2005

(30) Foreign Application Priority Data
Jan. 30, 2004 (JP) 2004-022402

(51) Int. Cl. G05D 1/00

(52) U.S. Cl. 700/245; 701/23

(57) ABSTRACT

An autonomous mobile robot cleaner system including a robot cleaner and remote controllers for guiding the robot cleaner to rooms so as to clean several rooms in a house automatically and successively in user-selected cleaning modes. The remote controllers are placed on a corridor in the vicinity of the entrances of rooms so that a user can operate them to input information including a number assigned to each room and a cleaning mode desired for the room. The robot cleaner communicates with each of the remote controllers to obtain the information while autonomously moving around. Based on the information, the robot cleaner selects a room and a cleaning mode, enters the selected room to clean the room in the selected cleaning mode. After cleaning the room, the robot cleaner moves to the corridor and thereafter communicates with a next remote controller to repeat the above process.

### BACKGROUND OF THE INVENTION

1. Field of the Invention

The present invention relates to autonomous mobile robot cleaner systems to clean rooms as autonomously moving around.

2. Description of the Related Art

A known autonomous mobile robot cleaner system includes a movement end station to be placed at a desired position in a room to be cleaned. The movement end station has an induction field generator means to generate signals receivable by an autonomous mobile robot of the system so as to allow a range of travel of the robot to be selected easily (see, for example, Japanese laid-open patent publication Hei 5-27833). Another known robot cleaner system uses a home server allowing a user to select a desired cleaning area from a plurality of cleaning areas and further to select a cleaning mode for the selected cleaning area. The system controls a robot thereof based on such selections so as to clean the selected cleaning area in the selected cleaning mode while autonomously moving in the area, thereby eliminating the need for input of a moving path that may be cumbersome (see, for example, Japanese laid-open patent publication 2002-85305).

However, the robot cleaner system as disclosed in Japanese laid-open patent publication Hei 5-27833, wherein the movement end station is provided, is not appropriate in a case where several rooms should be automatically and successively cleaned by the autonomous mobile robot. Further, the robot cleaner system as disclosed in Japanese laid-open patent publication 2002-85305 controls the robot by the home server. Therefore, the configuration is complex and thus the cost is high.

### SUMMARY OF THE INVENTION

An object of the present invention is to provide an autonomous mobile robot cleaner system that can clean several rooms in a house automatically and successively in desired cleaning modes while being simple to operate and low in cost.

According to a first aspect of the present invention, the above object is achieved by an autonomous mobile robot cleaner system comprising: a robot cleaner; and remote controllers serving as signposts for guiding the robot cleaner to rooms via wireless communication, wherein the robot cleaner includes: a sensor for use in autonomous movement; selection means for selecting a cleaning area from a plurality of cleaning areas and selecting a cleaning mode designated for the selected cleaning area, based on information received from each of the remote controllers via wireless communication; moving means for autonomously moving to the cleaning area selected by the selection means and thereafter autonomously moving in the cleaning area, based on an output of the sensor; cleaning means for cleaning the cleaning area selected by the selection means; and communication means for wirelessly communicating with the remote controllers, wherein each of the remote controllers includes: setting means placed in the vicinity of an entrance of each room, which is a unit of a cleaning area, so as to be operated by a user to designate a number assigned to said each room and a cleaning mode for said each room; and communication means for wirelessly communicating with the robot cleaner in regard to information stored in the setting means.

According to the first aspect of the present invention, the remote controllers are placed in the vicinity of the entrances of the respective rooms so that a user can operate them to designate the room numbers and the cleaning modes desired for the rooms. Accordingly, by only selecting the desired cleaning modes by means of the remote controllers provided for the respective rooms, a user can easily cause the robot cleaner to be guided into the rooms so as to clean the rooms in the user-selected modes while autonomously moving in the rooms. Since this autonomous mobile robot cleaner system does not require a home server or the like, it can be simple in configuration and low in cost.

Preferably, the autonomous mobile robot cleaner system further comprises: means for creating map information about an already cleaned area; and memory means for storing the map information, wherein one of the remote controllers is placed in association with a cleaning end area for presenting cleaning end information to the robot cleaner, wherein the robot cleaner performs a process of entering a room selected by the selection means via wireless communication with a remote controller and thereafter cleaning the room in a cleaning mode designated for the room, wherein after cleaning the room, the robot cleaner moves out of the room and wirelessly communicates with a next remote controller to repeat the process, and wherein when the robot cleaner wirelessly communicates with the remote controller presenting the cleaning end information, cleaning operation of the robot cleaner ends if all of the rooms are already cleaned.

By such a configuration, the remote controllers are arranged so that a user can operate them to designate the room numbers and the cleaning modes desired for the rooms and to input the cleaning end information associated with the cleaning end area. Accordingly, by only selecting e.g. the desired cleaning modes by means of the remote controllers for the respective rooms, a user can easily cause the robot cleaner to be successively and effectively guided into all of the rooms to be cleaned so as to clean the rooms in the user-selected modes while autonomously moving in the rooms. Since this autonomous mobile robot cleaner system does not require a home server or the like, it can be simple in configuration and low in cost.

Preferably, the remote controllers are placed on a corridor in the vicinity of entrances of the respective rooms with the setting means allowing a user to select desired cleaning modes for the respective rooms, and the selectable cleaning modes include a normal-cleaning mode, a careful-cleaning mode to clean a room carefully, a spot-cleaning mode to clean only a central region of a room, and a no-cleaning mode to skip cleaning of a room.

### BRIEF DESCRIPTION OF THE DRAWINGS

FIG. 1 is a schematic diagram showing a configuration of an autonomous mobile robot cleaner system according to an embodiment of the present invention.

FIG. 2 is a block diagram of a robot cleaner in the autonomous mobile robot cleaner system.

FIG. 3 is a schematic and perspective top plan view of the robot cleaner.

FIG. 4 is a schematic and partially cutaway side view of the robot cleaner,

FIG. 5 is a block diagram showing remote controllers in the autonomous mobile robot cleaner system.

FIG. 6 shows a layout example of a house in which the remote controllers are installed.

FIG. 7 is a flowchart showing an operation of the autonomous mobile robot cleaner system.

FIG. 8 shows an example of settings stored in the remote controllers.

### DETAILED DESCRIPTION OF THE PREFERRED EMBODIMENT

Referring now to the accompanying drawings, an embodiment of the present invention will be described.

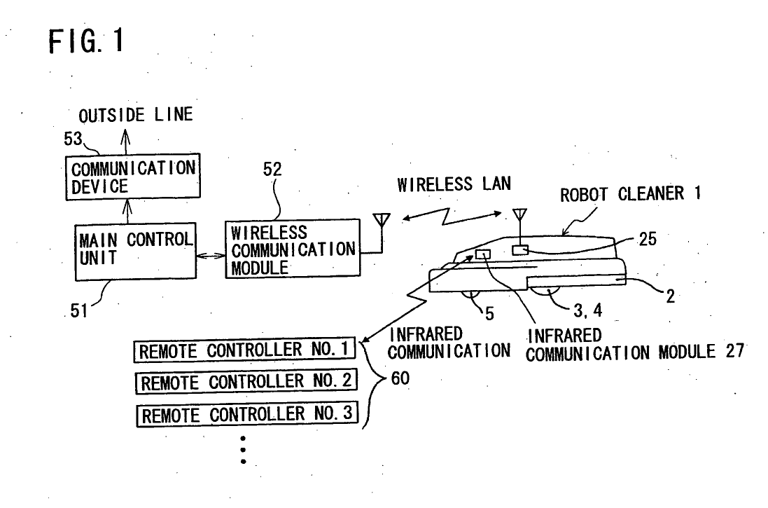

FIG. 1 shows a schematic configuration of an autonomous mobile robot cleaner system according to this embodiment. A robot cleaner 1 is a device that autonomously moves on a floor (cleaning area) of a room in a house to clean the floor, and comprises: a main body 2; a left wheel 3, a right wheel 4, and a front wheel 5 to move the main body 2; and a wireless communication module 25 and an infrared communication module 27 (communication means). The wireless communication module 25 communicates with a wireless communication module 52 in a main control unit 51, which is located within a house to serve as a monitoring center, on a wireless LAN for transmission of various data between them. The main control unit 51 is connected to an outside line via a communication device 53 such as a telephone or the like. The infrared communication module 27 wirelessly communicates with a plurality of remote controllers 60 each installed for each room to serve as signposts, which is a feature of the present invention. The autonomous mobile robot cleaner system according to the present invention comprises the robot cleaner 1 and the remote controllers 60, wherein the robot cleaner 1 communicates with the respective remote controllers 60 so that it is guided into selected rooms or cleaning areas to clean the rooms in selected cleaning modes while autonomously moving in the rooms.

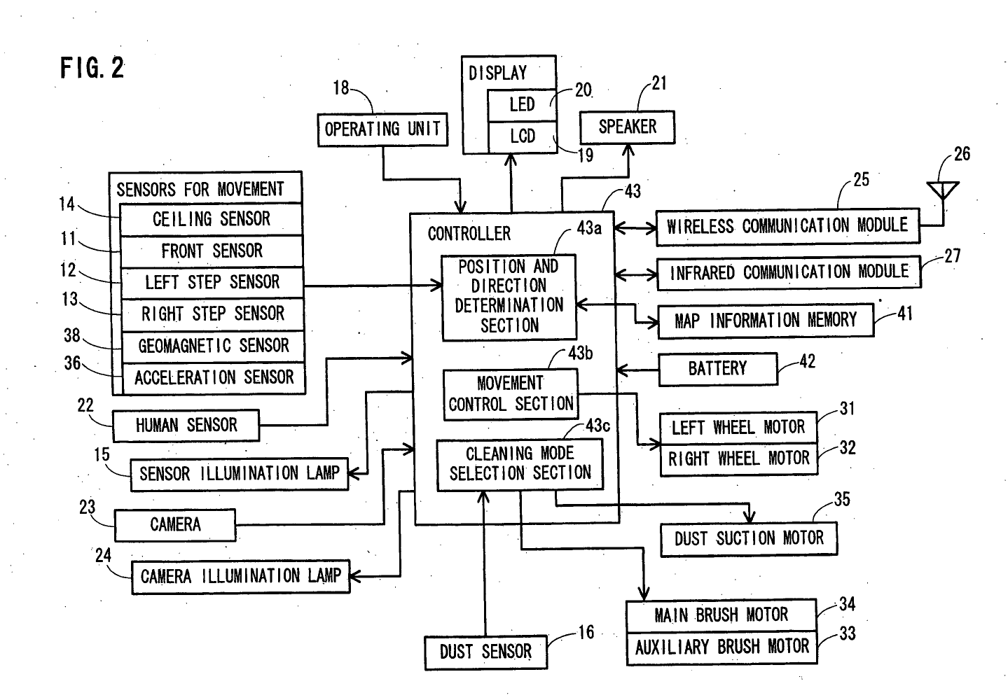

FIG. 2 is a block diagram of the robot cleaner 1. The robot cleaner 1 further comprises: sensors for autonomous movement, i.e., a front sensor 11, a left step sensor 12, a right step sensor 13, and a ceiling sensor 14 to detect obstacles around the main body 2, an acceleration sensor 36, and a geomagnetic sensor 38: and sensor illumination lamps 15. Each of the front sensor 11 the left step sensor 12, the right step sensor 13, and the ceiling sensor 14 is an optical distance sensor. The front sensor 11 monitors an area in front of the main body 2 downward diagonally so as to detect and measure distances to obstacles such as a step, a wall, a pillar, a furniture, a leg of a table or a bed, or the like. The left step sensor 12 monitors an area slightly in front of and left of the main body 2 downward diagonally so as to detect and measure distances to obstacles. The right step sensor 13 monitors an area slightly in front of and right of the main body 2 downward diagonally so as to detect and measure distances to obstacles. The ceiling sensor 14 monitors in front of the main body 2 upward diagonally to detect obstacles located above and in front of the main body 2 (as to whether or not it can pass through under a table, a bed or the like) and measures heights of and distances to the obstacles. The acceleration sensor 36 independently detects accelerations acting on the main body 2 in up-down direction, forward-backward direction, and left-right direction, respectively.

The robot cleaner 1 further comprises a dust sensor 16 to detect e.g. dust sucked by a suction nozzle. The dust sensor 16 is an optical transmission sensor having a light emitting unit and a light receiving unit.

The robot cleaner 1 further comprises an operating unit 18 to be operated by a user, an LCD (liquid crystal display) 19 as a display, an LED (light emitting diode) 20, a speaker 21, a controller 43 to control the respective elements, a map information memory 41 (memory means), and battery 42. The operating unit 18 is operated by a user to start and stop a cleaning operation of the robot cleaner 1, and to make various other settings. The LCD 19 and the LED 20 inform operational states of the robot cleaner 1 and various messages. The speaker 21 also informs operational states of the robot cleaner 1 and various messages. The controller 43 controls the respective elements based on output signals from e.g. the respective sensors and on information obtained via wireless communication with the remote controllers 60, and comprises a position and direction determination section 43a, a movement control section 43b, and a cleaning mode selection section 43c.

The position and direction determination section 43a creates map information about an area where an obstacle is present and an already cleaned area based on outputs of the front sensor 11, the left step sensor 12, the right step sensor 13, and the ceiling sensor 14, and stores the map information in the map information memory 41. Further, the position and direction determination section 43a time-integrates an output value of the acceleration sensor 36 in the forward-backward direction to thereby calculate a traveling speed of the robot cleaner 1. Based on the calculated traveling speed and the travel time, the position and direction determination section 43a calculates the travel distance. The position and direction determination section 43a further determines the direction in which the main body 2 faces based on an output value of the geomagnetic sensor 38 in accordance with the direction of the geomagnetic field.

The movement control section 43b controls the directions and speeds of rotations of the left wheel 3 and the right wheel 4 by controlling the rotations of a left wheel motor 31 and a right wheel motor 32 (moving means) so as to control movement of the main body 2. The map information stored in the map information memory 41 is updated at all times during a cleaning operation so that the robot cleaner 1 carries out the cleaning operation while reading the updated map information.

The cleaning mode selection section 43c controls selection of a cleaning mode. In accordance with a selected cleaning mode, the cleaning mode selection section 43c controls the rotations of the left wheel motor 31 and the right wheel motor 32 so as to adjust the travel area and the traveling speed of the main body 2, and further controls the rotations of an auxiliary brush motor 33, a main brush motor 34, and a dust suction motor 35 so as to adjust the dust collecting power. The operations of the respective sections in the controller 43 will be described later in more detail.

The robot cleaner 1 further comprises: the left wheel motor 31 to drive the left wheel 3 and the right wheel motor 32 to drive the right wheel 4 as the moving means; and the auxiliary brush motor 33, the main brush motor 34, and the dust suction motor 35 as cleaning means. The left wheel 3 and the right wheel 4 are drive wheels that are independently rotated in normal rotation and reverse rotation, and are steered by controlling the rotational frequencies. The front wheel 5 is an idler wheel.

The robot cleaner 1 furthermore has a security function of monitoring e.g. intruders, and comprises: a human sensor 22 to detect e.g. the intruders; a camera 23 to photograph e.g. the intruders; and a camera illumination lamp 24. The human sensor 22 detects presence or absence of a human body around the main body 2 by receiving infrared radiation from the human body. The camera 23 is provided to face in a direction diagonally forward and upward from the main body 2 so that it can photograph the face of standing human. A wireless communication module 25 wirelessly transmits images photographed by the camera 23 to the main control unit 51 via an antenna 26. When not in the cleaning operation, the robot cleaner 1 operates these human sensor 22, camera 23, camera illumination lamp 24, and wireless communication module 25 so as to monitor e.g. the intruders.

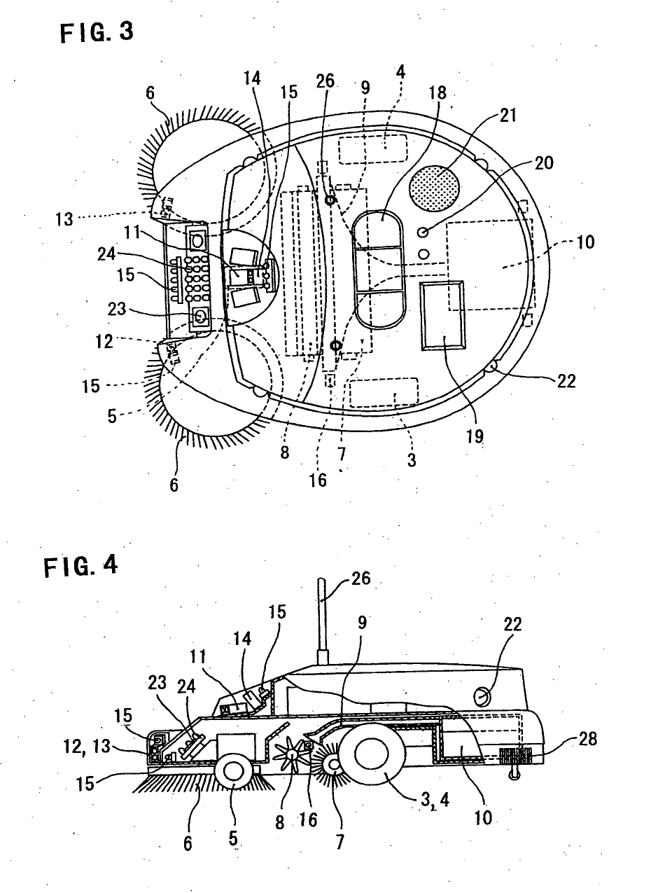

FIG. 3 and FIG. 4 are a schematic and perspective top plan view and a schematic and partially cutaway side view, respectively, of the robot cleaner 1. The robot cleaner 1 is provided with the above respective sensors, the moving means, the cleaning means, and so on as shown in FIG. 3 and FIG. 4. The robot cleaner 1 further comprises, as the cleaning means, left and right auxiliary brushes 6, a main brush 7, a driven roller 8, the suction nozzle 9, a dust suction fan 28, and a dust box 10 in which the dust is collected. The left and right auxiliary brushes 6, the main brush 7, and the dust suction fin 28 are driven by the auxiliary brush motor 33, the main brush motor 34, and the dust suction motor 35, respectively. The suction nozzle 9 sucks the dust gathered up by the main brush 7 and the dust transported by the roller 8 through the suction inlet into the dust box 10. The suction inlet of the suction nozzle 9 is provided at the underside of the main body 2 that faces the floor of a room and has a width elongated in the width direction of the main body 2 perpendicular to the moving direction.

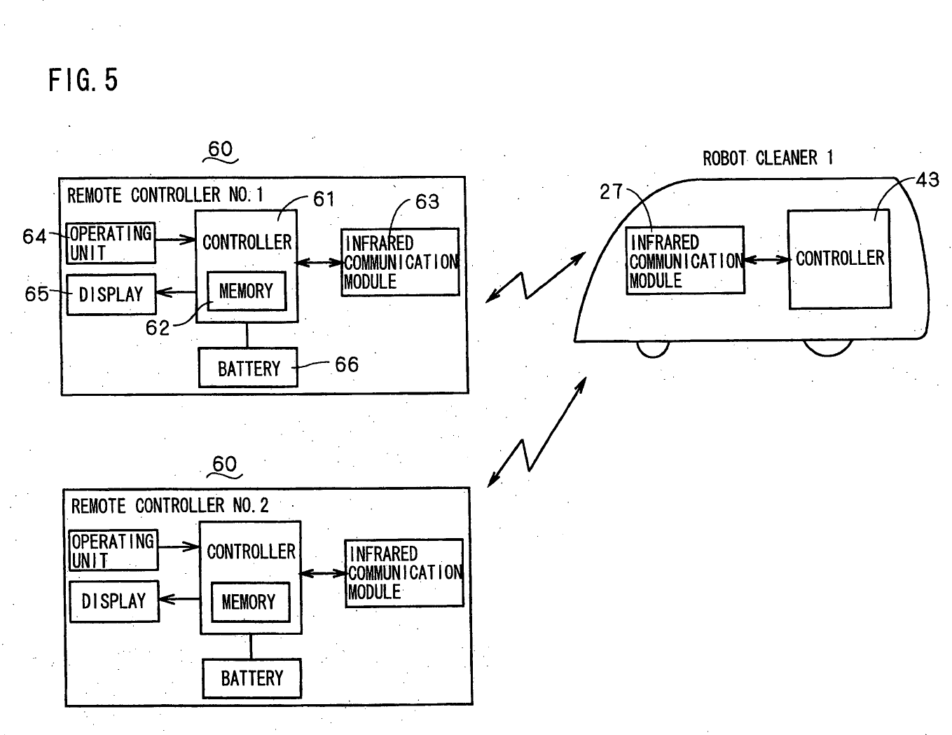

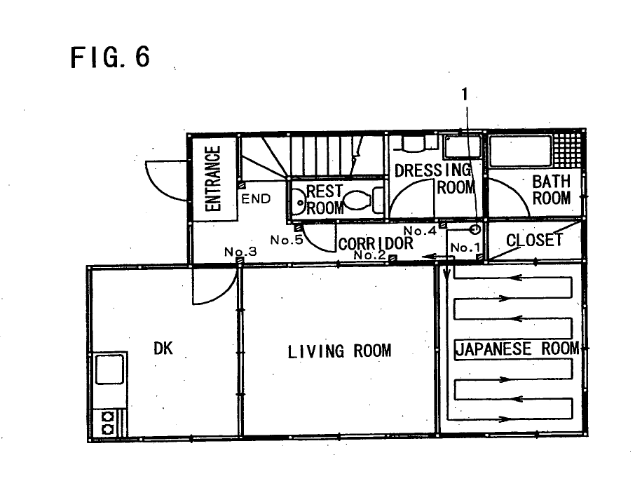

FIG. 5 is a block diagram of the robot cleaner 1 and the remote controllers 60 serving as signposts in the autonomous mobile robot cleaner system according to the present invention, for showing infrared communication between them. FIG. 6 shows a layout example of a house in which the remote controllers 60 are installed. Each of the remote controllers 60 comprises a controller 61 having a memory 62, an infrared communication module 63 (communication means) for infrared communication, an operating unit 64, a display 65, and a battery 66. In this example, six remote controllers 60 “No. 1” to “No. 5” and “END” are placed on the corridor in the vicinity of the entrances of rooms, which are units of cleaning areas, so as to guide the robot cleaner 1 to the respective rooms so that the robot cleaner 1 cleans the respective rooms in user-selected cleaning modes. One of the remote controllers 60 that is denoted by “END” is placed in association with the area in which the cleaning operation is to end.

Prior to the cleaning operation, a user operates the operating unit 64 in each of the remote controllers 60 to input information including a number assigned to each room and a cleaning mode desired for the room, which the controller 61 stores in the memory 62. Setting means comprises the operating unit 64 and the controller 61. The controller 61 communicates the information stored in the memory to the infrared communication module 27 in the robot cleaner 1 through infrared signals. Based on the information received from the remote controllers 60 through the infrared communication, the robot cleaner 1 selects the cleaning modes designated for the respective rooms in order of the room number. Selection means for selecting a cleaning area from a plurality of cleaning areas and selecting a cleaning mode for the cleaning area comprises the operating unit 18 of the robot cleaner 1 and the cleaning mode selection section 43c of the controller 43 of the robot cleaner 1.

In the example shown in FIG. 6, the robot cleaner 1 is initially placed in the vicinity of the back of the corridor (start point). The remote controllers “NO. 1” to “No. 5” and “END” are placed on e.g. the walls of the corridor in the vicinity of the entrances of a Japanese room, a living room, a dining kitchen (DK), a dressing room, and a rest room, and in the vicinity of stairs, respectively.

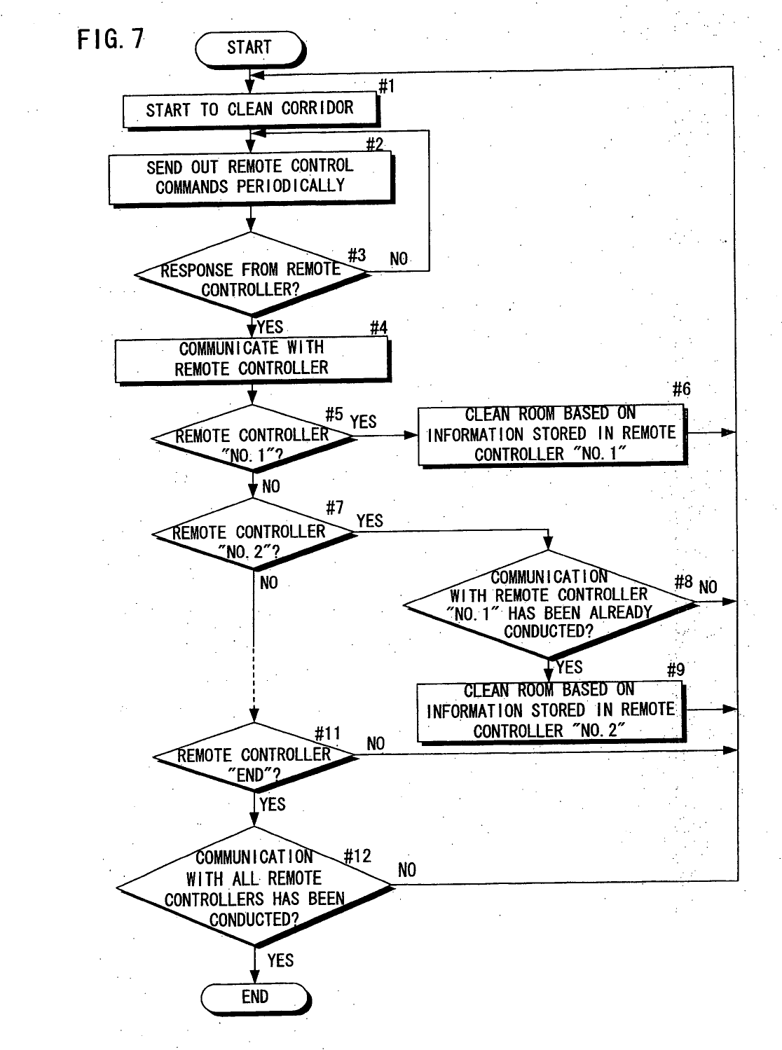

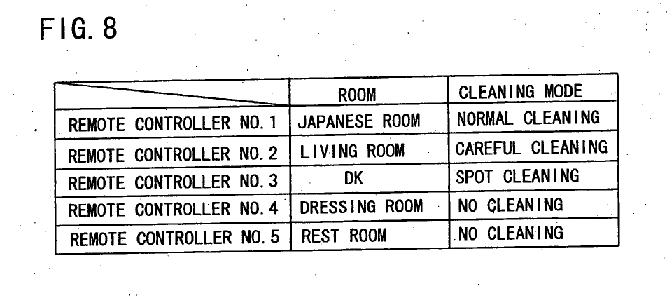

FIG. 7 is a flowchart showing the steps carried out by the robot cleaner 1 in the cleaning operation. FIG. 8 shows an example of cleaning mode settings stored in the respective remote controllers 60. In response to a cleaning start command, the robot cleaner 1 starts autonomous movement from the start point shown in FIG. 6 to clean the corridor (#1). The robot cleaner 1 sends out remote control commands (codes) periodically (#2), and waits for a response from a remote controller (#3). If the robot cleaner 1 can communicate with the remote controller “No. 1” (YES at #4 and #5), it selects the cleaning mode designated for the Japanese room that is stored in the remote controller “No. 1” so as to clean the Japanese room in the selected cleaning mode (#6). The solid arrow in FIG. 6 indicates the moving path of the robot cleaner 1. During the cleaning operation, the robot cleaner 1 creates the map information in regard to already cleaned areas based on output signals of the respective sensors, and stores the map information in the map information memory 41. After cleaning the Japanese room, the robot cleaner 1 gets out of the Japanese room to the corridor and cleans the corridor while autonomously moving in the corridor again. Thereafter, if the robot cleaner 1 can communicate with the next remote controller “No. 2” (YES at #7 and #8), it selects the cleaning mode designated for the living room that is stored in the remote controller “No. 2” to clean the room in the selected mode (#9). In such a manner, the robot cleaner 1 repeats the above process by sequentially communicating with the following remote controllers “No. 3”, “No. 4”, and “No. 5”. When the robot cleaner 1 encounters and communicates with the last remote controller “END” after cleaning all of the rooms to be cleaned (YES at #11 and #12), the cleaning operation ends.

Referring now to FIG. 8, a description will be made as to the cleaning modes selectable by a user. In a normal-cleaning mode, for example, the robot cleaner 1 cleans a room while moving zigzag along a moving path as indicated by the solid arrow in FIG. 6. In a careful-cleaning mode, for example, the robot cleaner 1 cleans a room twice or cleans a room while moving along two paths crossing each other in both the lengthwise and lateral directions. In a spot-cleaning mode, for example, the robot cleaner 1 cleans only the central region of a room while moving spirally. In a no-cleaning mode, the robot cleaner 1 skips cleaning of a room. It is noted that the doors of rooms to be cleaned should be open so as to allow the robot cleaner 1 to enter the rooms. Further, the map information about already cleaned areas is updated during the respective cleaning processes to be stored in the map information memory 41.

As is evident from the foregoing, the robot cleaner 1 cleans rooms or cleaning areas in user-selected cleaning modes stored in the remote controllers that are installed in association with the respective rooms while autonomously moving in the rooms. Accordingly, by only selecting e.g. the cleaning modes by means of the remote controllers provided for the respective rooms, a user can cause the robot cleaner 1 to be successively and effectively guided into the rooms so as to clean the rooms in the modes selected for the respective rooms while autonomously moving in the rooms. In other words, the system can eliminate the need for a home server or the like so as to be simple in configuration and low in cost.

Preferably, if the battery 42 needs recharging during a cleaning operation, the robot cleaner 1 informs the main control unit 51 or a charging robot not shown about the need via the wireless communication modules 25 and 52. Further, the main control unit 51 can be configured to display a current position of the robot cleaner 1. This allows a user to quickly know the position of the robot cleaner 1 without trouble to look for it.

The present invention has been described above using a presently preferred embodiment, but those skilled in the art will appreciate that various modifications are possible. Accordingly, all such modifications are intended to be included within the spirit and scope of the present invention. For example, the means for communication between the robot cleaner and the remote controllers is not limited to the infrared communication module but can use ultrasonic communication or radio communication.

This application is based on Japanese patent application 2004-22402 filed in Japan dated Jan. 30, 2004, the contents of which are hereby incorporated by references.

1. An autonomous mobile robot cleaner system comprising:
a robot cleaner; and
remote controllers serving as signposts for guiding the robot cleaner to rooms via wireless communication,
wherein the robot cleaner includes:
a sensor for use in autonomous movement;
selection means for selecting a cleaning area from a plurality of cleaning areas and selecting a cleaning mode designated for the selected cleaning area, based on information received from each of the remote controllers via wireless communication;
moving means for autonomously moving to the cleaning area selected by the selection means and thereafter autonomously moving in the cleaning area, based on an output of the sensor;
cleaning means for cleaning the cleaning area selected by the selection means; and
communication means for wirelessly communicating with the remote controllers,
wherein each of the remote controllers includes:
setting means placed in the vicinity of an entrance of each room, which is a unit of a clearing area, so as to be operated by a user to designate a number assigned to said each room and a cleaning mode for said each room; and
communication means for wirelessly communicating with the robot cleaner in regard to information stored in the setting means.

2. The autonomous mobile robot cleaner system according to claim 1, further comprising:
means for creating map information about an already cleaned area; and
memory means for storing the map information,
wherein one of the remote controllers is placed in association with a cleaning end area for presenting cleaning end information to the robot cleaner,
wherein the robot cleaner performs a process of entering a room selected by the selection means via wireless communication with a remote controller and thereafter cleaning the room in a cleaning mode designated for the room,
wherein after cleaning the room, the robot cleaner moves out of the room and wirelessly communicates with a next remote controller to repeat the process, and
wherein when the robot cleaner wirelessly communicates with the remote controller presenting the cleaning end information, cleaning operation of the robot cleaner ends if all of the rooms are already cleaned.

3. The autonomous mobile robot cleaner system according to claim 2,
wherein the remote controllers are placed on a corridor in the vicinity of entrances of the respective rooms with the setting means allowing a user to select desired cleaning modes for the respective-rooms,
wherein the selectable cleaning modes include a normal-cleaning mode, a careful-cleaning mode to clean a room carefully, a spot-cleaning mode to clean only a central region of a room, and a no-cleaning mode to skip cleaning of a room.
